(19) United States
(12) Patent Application Publication
(10) Pub. No.: US 2009/0198001 A1
(43) Pub. Date: Aug. 6, 2009

(54) Use of a bridged bisanthraquinone dye derivate

(75) Inventors: Pedro Jesus Gonzalez Martinez, Barcelona (ES); Joan Jesus Tugues Roure, Barcelona (ES); Jean-Francois Wittmann, Illzach (FR); Susana Basolastena, Barcelona (ES)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Road Town, Tortola (VG)

(21) Appl. No.: 11/630,771

(22) PCT Filed: Jun. 24, 2005
(86) PCT No.: PCT/EP05/52962

§ 371 Date: Dec. 22, 2006

(30) Foreign Application Priority Data
Jun. 25, 2004 (EP) 04014910.6

(51) Int. Cl. C08K 5/07

(52) U.S. Cl. 524/242

(57) ABSTRACT

The present invention relates to the use of a compound of the formula (I)

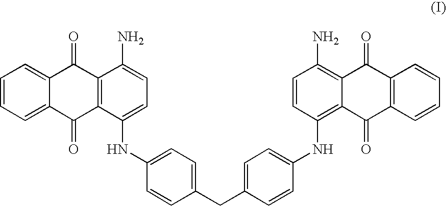

in mass coloration which provides dyed polymers with excellent overall fastness properties.

The present invention relates to novel use of a colorant based on a bridged bisanthraquinone dye derivative for the in mass coloring of polymers. The present invention further relates to a method for mass coloring of polymers.

The presently used colorants lack in heat stability, color fastness and thermostability. Furthermore the presently used colorants are not stable under the conditions the dyed polymers are subjected to.

The object of the present invention therefore is to provide method for mass coloration of polymers with very high fastness levels and very good thermostability properties.

The present invention relates to the use of a compound of the formula (I)

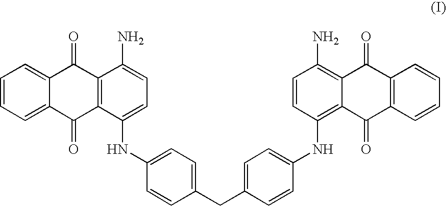

in mass coloration provides dyed polymers with the required properties.

Therefor the invention relates to a method for mass-dyeing a polymer using a as dyestuff, a compound of formula (I). The invention further relates to a mass-dyed polymer comprising, as dyestuff, a compound of formula (I).

The colorant used in the method of the present invention provides excellent compatibility with the polymer substrate, excellent heat stability and light fastness as required for mass coloring of polar and non-polar polymers. Polar polymers are for example polyamides, polyesters, polycarbonates and ABS; non-polar polymers are olefinic polymers such as polyethylene and polypropylene.

The present invention further relates to a method for dyeing polymers which comprises the steps of mixing polymer granules or polymer melts or polymer powders with the colorant by conventional methods and then forming objects with the mixture of the polymer and the dye according to the formula (I).

The mass-dyeing is carried out in conventional manner The compounds of formula (I) and, if desired, in admixture with one or more other dyes indicated for the mass-dyeing of polyester, may be purified and ground in conventional manner prior to their incorporation.

The incorporation of the polymer into the polymer is made in a conventional manner like, e.g. by means of an extruder device.

When mixing the polymer with the dyestuff of formula (I), the dystuff may be used in solid form or in a liquid form which means that the dyestuff is dispersed or dissolved in appropriate solvent as for example a low melting polymer.

The mixing of the dyestuff(s) with low-melting polymer is suitably effected at low temperature, e.g. employing dry ice as coolant, and grinding them together to form a fine powder and, optionally, processing the powder through an extruder and forming chippings or a granulate from the extrudate.

Thereafter shaped objects and/or shaped articles are formed e.g. fibres, films, profiles, pipes, granules or powders are formed—for example, in melt spinning, injection or blow molding, extrusion, film blowing, stretch blow molding in a appropriate injection moulding or spinning machine.

In one embodiment only the dyed polymer granules or polymer melts or polymer powders are used to form the desired objects.

In a second embodiment only a part of the polymer granules or polymer melts or polymer powders are dyed and are mixed with colorless (undyed) polymer granules or polymer melts or polymer powders before forming the objects. In this second embodiment the concentration of the dye in the dyed polymer granules or polymer melts or polymer powders is higher as the concentration in the final shaped objects and/or shaped articles. The dyed polymer granules or polymer melts or polymer powders of the second embodiment are so-called “master-batches”. These so-called “master-batches” comprise generally 10 to 80% by weight of dyestuff, preferably 30 to 60% by weight of dyestuff.

The color concentrates of the second embodiment, either in liquid form or in the pellet form (masterbatch) have to be mixed with the uncoloured resin in a particular let-down ratio in order to achieve the desired colour. The mixing can be done either by manual mixing, or, more commonly, by a batch-blend process using automated dosing equipment.

Liquid colours are normally pumped directly into the feed throat of the processing machine (e.g. an injection molding machine, a blow molding machine, a melt spinning system or the like) by using a small peristaltic pump.

By preference the use of masterbatches is the preferred method for colouring of plastics. Ease of handling and low costs compared to pre-colored resins are the main advantages for these products. Unlike liquid colors, the compatibility of masterbatches with the resin is excellent, since the carrier material of the masterbatch is in the most preferred cases identical with the resin.

An example of such automated dosing equipment for masterbatches is the volumetric feeding unit as represented by FIG. 1 in WO2004/022633. The feeding unit comprises a resin feeder next to a masterbatch feeder, a mixer in a mixing area, a flap between the mixing unit and the hopper and a hopper mounted on an extruder or injection molder. The resin feeder, the masterbatch feeder, the mixer and the flap are controlled by a control unit, comprising a detector at the passage way from the hopper to the extruder or injection molder.

Masterbatches are commonly supplied in pellet or in micro-pellet form. There are few ways to produce a masterbatch. The first and most common way used by the masterbatch manufacturers is a so called one step process. During this process, pigments (or dyes), functional additives and the polymer carrier are mixed, the mixture is then processed through a dispersion unit, e.g. a co-rotating twin screw extruder.

The color concentrates (masterbatches) comprising the compound of formula (I) can also be obtained in a so called two step process, wherein in a first step, the masterbatch manufacturers produce a Single Pigment Concentrate (SPC) comprising the compound of formula (I). SPC is a masterbatch preparation containing only one pigment or dye (generally in very high concentration) fully dispersed in a resin carrier optionally comprising further additives. This first process step is very similar to the one step process.

In a second step, different SPCs are mixed together in order to achieve the required color specifications of the customer and to get the tailor made masterbatch. To reduce the pigment concentration, the SPCs are mixed together with some carrier resin. Since SPCs are already fully dispersed, only a mixing process is necessary. This can be performed for example with a single screw or twin screw extruder.

After addition of the master-batch, whether in powder, chippings or granulate form, to the undyed polymer, the resulting mix can be formed into shaped articles, such as films, foils, fibres or filaments, in conventional manner, e.g. by extrusion or spinning techniques, and such articles further processed, e.g. into yarn, cord, rope, woven, non-woven and knitted goods, or the mix can be formed into granules or chippings for subsequent melting and formation into such shaped articles.

The compound of formula (I) as well as being employable for the mass-dyeing of polymer by the method described above, can also be incorporated in the polymer by co-condensation with the polymer precursors. Such co-condensation may be carried out in conventional manner employing varying amounts of the compounds depending on the depth of shade desired.

The mass-dyed polymers according to the invention have good all round fastness properties, e.g. to light, migration, gas-fumes, ozone and sublimation, as well as good wet fastness. Furthermore the mass-dyed polymers according to the invention have a good fastness under dry cleaning conditions e.g. against warm perchhloroethylene and the dyed polymers have good fastness against aqueous hypochlorite solutions and good fastness against rubbing when wet. Of particular interest, however, is the fact that the compound of formula (I) shows very good resistance to the extreme conditions employed in extrusion and especially spinning operations performed to produce shaped articles.

It is always possible to add more or different additional dyestuffs or to add additives before forming the desired objects in order to adjust the color shade or to impart additional desired properties. Besides further colorants at least one active ingredient selected from the group consisting of anti-blocking, anti-fogging, anti-microbial, antioxidant, anti-slipping, anti-static or cleaning agents, compatibilizers, conductive agents, corrosion inhibitors, de-nesting agents, drying agents, fillers, flame retardants, foaming agents, infrared agents, laser marker agents, lubricants, matting agents, nucleating agents, opacifiers, optical brightener, phosphorescent agents, photodegradable agents, processing aids and/or UV stabilisers may be added before the object forming stage. Alternatively the at least on active ingredients may also be admixed already in the stage of mixing the polymer granules or polymer melts or polymer powders with the dyestuff of formula (I).

The novel method according to the invention using the dyestuff according to the formula (I) give blue coloration in synthetic non polar or polar polymers, such as for example polyethylene, polypropylene, ABS, polyester, polycarbonate or polyamides.

The polyester, itself, is preferably linear, highmolecular weight, saturated, aromatic polyester and especially that produced by polycondensation of terephthalic acid and, optionally, isophthalic acid, with ethylene glycol and/or cyclohexanediol. Typically, it is the polyester employed in the textile industry.

The preferred polymer is a polyester wherein polyethyleneterephthalate is the most preferred polyester. The preferred poly(ethylene-terephthalate) is a linear (1,4)-poly(ethylene-terephthalate).

The preferred method of producing the preferred high molecular weight, mass-dyed polyester according to the invention is first to mix the dyestuff(s) with a relatively low-melting, linear, aromatic polyester, typically having a melting point in the range from 75° C. to 230° C. and a softening point in the range of 60° C. to 80° C. to form a concentrate or so-called “master-batch” containing generally 30 to 60% by weight of dyestuff, and then adding this master-batch in molten form, in the desired amount, depending on the depth of colour required in the final polyester, to the molten high molecular weight polyester, and distributing the dyestuff throughout the melt. Alternatively after forming the a concentrate or so-called “master-batch” containing generally 30 to 60% by weight of dyestuff, this masterbatch may be cooled down and powdered or be brought into chippings and the mixed with undyed polyester and be mixed by mixing and kneating the polymers powders and/or chippings until a homogenous polymer mass results.

In the description, in the claims and in the examples below, all parts are parts by weight and % means weight-% unless it is otherwise defined.

### EXAMPLE 1

202 parts of C.I. Acid Blue 127:1 having the formula

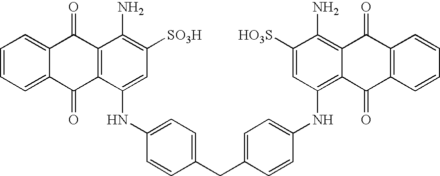

were dispersed in 2000 parts of water. The mixture was heated to 80° C. When the temperature of the mixture reached 80° C., sodium hydrosulphite was added while at the same time a 25% sodium hydroxide solution was added in order to maintain the pH at 8,5. After the desulphonation the temperature was lowered to 65° C. and 50 parts of a sodium hydroxide solution (25%) were added in order to adjust pH at 12. Additionally 140 parts of hydrogen peroxide were added. The product was filtered off and washed with water. 145 parts of the product of formula (I) were obtained.

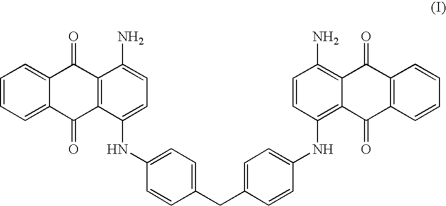

### EXAMPLE 2

### 1% of the Dye According to the Formula (I) in Polypropylene Fibres

100 parts of polypropylene in the form of a powder are mixed with 0.1 and with 1.0 part respectively of the dye according to the formula (I) in powder form in a drum mixer.

After a short time, the powder is uniformly distributed. After about 10 minutes, the mixture is dried at 120° C. for 16 hours, transferred to a melt spinning machine and following a residence time of about 8 minutes is spun to fibers at 275-280° C. under a nitrogen atmosphere. The colored fibers are extremely lightfast.

All other known synthetic polymers can be mass-colored in the same way, e.g. (HD/LD) polyethylene, polyamides, polyesters, ABS, polycarbonates.

### EXAMPLE 3

### 0.1% of the Dye According to the Formula (I) in Polyamide Fibres

100 parts of polycaprolactam in the form of a powder are mixed in a drum mixer with 0.1 parts of the dye according to the formula (I) in powder form. After a short time, the powder is uniformly distributed. After about 10 minutes, the mixture is dried at 120° C. for 16 hours, transferred to a melt spinning machine and following a residence time of about 8 minutes is spun to fibres at 275-280° C. under a nitrogen atmosphere. The blue colored polyamide fibres are extremely lightfast.

### EXAMPLE 4

### 0.1% of the Dye According to the Formula (I) in Polyester Fibres

Polyester fibres containing 0.1 parts of the dye according to the formula (I) have been prepared according to the following method: the polyester mixed with the dye is fused and extruded through a drawing plate at constant rate by gear pump regulation. The spinning machine is heated during 2 hours at temperatures of 260-265° C. under pressure of 80 bars. The drawing plate is heated in an oven at 350° C. for at least 30 minutes. The obtained fibres are recovered on a bobbin. The obtained fibres provide a strong blue color with excellent light and weather fastness.

### EXAMPLE 5

1000 Parts of a commercial linear copolyester, formed by co-condensation of terephthalic acid, isophthalic acid, ethylene glycol and neopentyl glycol, and having a molecular weight of between 18,000 and 20,000, a melting range of between 90° C. and 150° C., and softening point of 65° C., are ground to a powder together with 1000 parts of dry ice in a pin mill which has been cooled to about −30° C. with dry ice, and the polyester particles then have a diameter of between 300 and 600 micro-meter. This polyester powder is mixed well at room temperature in a closed mixer with 500 parts of the finely ground dyestuff of formula (I), and this is subsequently processed in an extruder at 130° C. to form a cable which is then cut to a granulate.

The dyestuff concentrate, produced as described above, is melted in the shunt current of a helical spinning machine and is added at 270-275° C. by a metering device to commercial, linear, aromatic polyester (polyethylene terephthalate) in the primary current of the spinning machine. The metering device adds to the polyester current 1 part of dyestuff concentrate per 48 parts of polyethylene terephthalate. The mixture is then spun at 270° C.-275° C. at a winding off speed of 200 meters per minute, the spun fibres are stretched at 90° C. in a drawing machine in the ratio of 1:4, and are twisted in the usual manner in a ring twister. A blue mass-dyed yarn is thus obtained with good fastness properties.

### EXAMPLE 6

1360 Parts of ethylene glycol and 1700 parts dimethyl terephthalate were stirred with 0.55 parts of manganese acetate for 3½ hours at 180° C. and the methanol produced was distilled off.

The mass is then transferred to a vacuum container suitable for polycondensation and a mixture of 80 parts of ethylene glycol, 0.45 parts of antimony trioxide, 20 parts of tri-nonyl phenyl phosphite and 17 parts of the dyestuff of formula (I) (in powder form) added thereto. The vacuum was successively increased to less than 1 Torr at 275° C., until the intrinsic viscosity of eta=0.70 is reached by distillation of ethylene glycol.

The dyed polyester obtained is then extruded and granulated. The granules are vacuum dried at 140° C. for 16 hours and finally spun, stretched and twined as described in Example 5. A blue yarn is obtained.

### EXAMPLE 7

Using the method of example 6a polyester flat yarn of 5,5 dtex was produced. Two batches were produced: one comprising 0.1% colorant of formula (I) and one in mass dyed having a deeper shade and comprising 1% of formula (I). These yarns were used to produce non-woven swatches. These swatches made of in mass-dyed fibres of this example were tested in the following manner:

The dyed swatches were exposed to light according to ISO 105/B02 test Exposure takes place in Atlas Ci 35/A equipped with a Xenon arc source; black standard temperature 63° C., relative humidity 45±5%.

Afterwards (in both tests) the adjacent fabrics are assessed by the Grey Scale Change ISO A03. This 5-step Grey Scale consists of 5 pairs of swatches of grey and which illustrate the perceived color differences corresponding to fastness ratings 5, 4-5, 4, etc.

The fastness rating is that number of the Grey Scale which has a perceived color difference equal in magnitude to the perceived color difference between the original adjacent fabric and the treated adjacent fabric. An improvement of a value by 1 signifies an improvement of 20%.

| | marking polymer | marking polymer |
|---|---|---|
| | comprising 0.1% | comprising 1% |
| | dyestuff | dyestuff |
| ISO 105/B02 during 40 hours | 4-5 | 4-5 |
| ISO 105/B02 during 70 hours | 3-4 | 4-5 |
| ISO 105/B02 during 90 hours | 3-4 | 4-5 |

1. A mass-colored polymer colored by a compound, wherein the compound is of the formula (I) 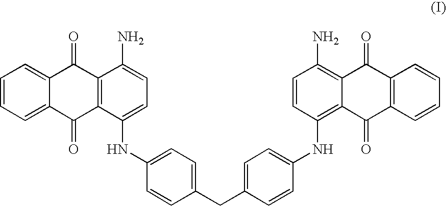
.

2. The mass-colored polymer according to claim 1 wherein the polymer is a polar synthetic polymers.

3. The mass-colored polymer according to claim 1, wherein the polymer is a non polar synthetic polymer.

4. The mass-colored polymer according to claim 2, wherein the polar synthetic polymer is a polyester.

5. A process of forming a mass colored polymer comprising the steps of homogenously mixing a compound of formula (I) 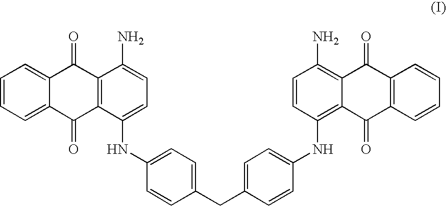
with a polymer to form a dyed polymer and shaping the polymer by a shaping operation selected from the group consisting of melt spinning, injection molding, blow molding, extrusion, film blowing and strech blow molding.

6. The process according to claim 5 wherein the mixing step further comprises homogenously mixing the dyed polymer of the with an undyed polymer and to form a second dyed polymer and wherein the shaping step further comprises shaping the second dyed polymer by a shaping operation.

7. A mass-colored polymer made in accordance with the process of claim 5.

8. The mass-colored polymer according to claim 1, wherein the polymer is selected from the group consisting of polyamides, polyesters, ABS and polycarbonates.

9. The polymer according to claim 1, wherein the polymer is polyethylene or polypropylene.

10. The polymer according to claim 2, wherein the polyester is a linear polyester.

11. A mass-colored polymer made in accordance with the process of claim 6.
